(19) United States
(12) Patent Application Publication
(10) Pub. No.: US 2019/0045582 A1
(43) Pub. Date: Feb. 7, 2019

(54) DUAL-CORE COMMUNICATION METHOD, DEVICE, MOBILE TERMINAL, COMMUNICATION METHOD, AND STORAGE MEDIUM

(71) Applicant: NUBIA TECHNOLOGY CO., LTD., Shenzhen (CN)

(72) Inventor: Jian HE, Shenzhen (CN)

(21) Appl. No.: 16/072,652

(22) PCT Filed: Jul. 27, 2016
(86) PCT No.: PCT/CN2016/091946

§ 371 Date: Jul. 25, 2018

(30) Foreign Application Priority Data
Jan. 27, 2016 (CN) 201610056492.5

(51) Int. Cl. H04W 88/10; H04W 8/18; H04W 8/24; H04W 8/00

(52) U.S. Cl. CPC H04W 88/10; H04W 8/005; H04W 8/24; H04W 8/18

(57) ABSTRACT

The present invention provides a dual-core communication method, device, mobile terminal, communication method and storage medium. The dual-core communication method includes: when a preset condition is satisfied, sending, by a second processor, a synchronization frame to a first processor; after receiving the synchronization frame sent by the second processor, replying, by the first processor, an acknowledgement frame to establish a connection with the second processor; registering, by the first processor, a preset service; and executing, by the second processor, service discovery and registering a client corresponding to the preset service to exchange information with the first processor. The beneficial effects of implementing the present invention include that the obtained information is shared with another processor through a data interface to enable instant access to information. Further, different ports are registered for different services to perform corresponding transmission, which supports extending a plurality of transmission layer protocols and a plurality of physical layer protocols.

### FIELD OF THE DISCLOSURE

The present disclosure generally relates to the field of communication technology and, more particularly, relates to a dual-core communication method, device, mobile terminal, communication method, and storage medium.

### BACKGROUND

With the development of mobile communication technologies, advanced cellular networks (e.g., networks based on LTE standards (long-term evolution, standards used by some 4G networks)) are being deployed all over the world. Due to the introduction of orthogonal frequency division multiplexing (OFDM), multi-input & multi-output (MIMO), and other key technologies, use of the 4G related standards can significantly increase the spectral efficiency and the data transmission speed.

On the other hand, as network speed and band-utilization efficiency are improved, the emergence of a multi-mode terminal (a terminal having two subscriber identity cards, e.g., a mobile terminal) enables users to establish data service links while implementing voice service standby.

However, the existing multi-mode terminal cannot implement sharing information of multi-subscriber identity cards.

The existing technology has drawbacks and still needs to be improved.

### BRIEF SUMMARY OF THE DISCLOSURE

Aiming at the above drawbacks of the prior art, the disclosed embodiments of the present invention provides a dual-core communication method, device, mobile terminal, communication method, and storage medium.

The technical solutions adopted by the disclosed embodiments of the present invention for solving the technical issues include the following.

One aspect of the present disclosure includes a dual-core communication method, comprising:

when a preset condition is satisfied, sending, by a second processor, a synchronization frame to a first processor;

after receiving the synchronization frame sent by the second processor, replying, by the first processor, an acknowledgement frame to establish a connection with the second processor;

registering, by the first processor, a preset service; and

executing, by the second processor, service discovery and registering a client corresponding to the preset service to exchange information with the first processor.

In one embodiment, the preset service includes a service for obtaining information of a subscriber identity card; and exchanging information includes exchanging the information of the subscriber identity card obtained by the first processor.

In one embodiment, a data packet format adopted for exchanging information includes at least one of: a flag bit, a length, a control flag, a port number, a service ID, a customer ID, a data ID, a control bit, a message ID, a data length, and data.

In one embodiment, the data includes a field indicating a type of an entire data block, a field indicating a size of a data field, and the data field.

In one embodiment, the method further includes:

configuring, for the first processor, a first logical port corresponding to the preset service and a second logical port corresponding to a physical interface of the first processor; and

transmitting information obtained by the preset service to the second logical port through the first logical port, and to the second processor through the physical interface of the first processor.

In one embodiment, the method further includes:

configuring, for the second processor, a third logical port corresponding to a client and a fourth logical port corresponding to a physical interface of the second processor; and

transmitting information received by the physical interface of the second processor to the third logical port through the fourth logical port, and to the client.

In one embodiment, the physical interface of the first processor includes one of an I/O interface, a UART interface, a USB interface, and an I2C interface; and

the physical interface of the second processor includes one of an I/O interface, a UART interface, a USB interface, and an I2C interface.

Another aspect of the present disclosure includes a dual-core communication device, comprising:

a first processor and a second processor, wherein:

the second processor is configured to send a synchronization frame to the first processor when a preset condition is satisfied;

the first processor is configured to reply an acknowledgement frame to establish a connection with the second processor after receiving the synchronization frame sent by the second processor, and configured to register a preset service; and

the second processor is configured to execute service discovery and register a client corresponding to the preset service to exchange information with the first processor.

In one embodiment, the first processor is further configured with a first logical port corresponding to the preset service and a second logical port corresponding to a physical interface of the first processor; and

information obtained by the preset service is transmitted to the second logical port through the first logical port, and transmitted to the second processor through the physical interface of the first processor.

In one embodiment, the second processor is further configured with a third logical port corresponding to a client and a fourth logical port corresponding to a physical interface of the second processor; and

information received by the physical interface of the second processor is transmitted to the third logical port through the fourth logical port, and transmitted to the client.

Another aspect of the present disclosure includes a mobile terminal, comprising:

a first subscriber identity card and a second subscriber identity card; and

a first modem processor and a second modem processor connected to the first modem processor, wherein:

when a preset condition is satisfied, the second modem processor is configured to send a synchronization frame to the first modem processor;

after receiving the synchronization frame sent by the second modem processor, the first modem processor is configured to reply an acknowledgement frame to establish a connection with the second modem processor;

the first modem processor is configured to register a preset service to obtain information of one or more of the first subscriber identity card and the second subscriber identity card; and

the second modem processor is configured to execute service discovery and register a client corresponding to the preset service to exchange the information of one or more of the first subscriber identity card and the second subscriber identity card with the first modem processor.

In one embodiment, a data packet format adopted for exchanging the information of one or more of the first subscriber identity card and the second subscriber identity card includes at least one of: a flag bit, a length, a control flag, a port number, a service ID, a customer ID, a data ID, a control bit, a message ID, a data length, and data.

In one embodiment, the data includes a field indicating a type of an entire data block, a field indicating a size of a data field, and the data field.

In one embodiment, the first modem processor is further configured with a first logical port corresponding to the preset service and a second logical port corresponding to a physical interface of the first modem processor; and

information of one or more of the first subscriber identity card and the second subscriber identity card is transmitted to the second logical port through the first logical port, and transmitted to the second modem processor through the physical interface of the first modem processor.

In one embodiment, the second modem processor is further configured with a third logical port corresponding to a client and a fourth logical port corresponding to a physical interface of the second modem processor; and the information of one or more of the first subscriber identity card and the second subscriber identity card received by the physical interface of the second modem processor is transmitted to the third logical port through the fourth logical port, and transmitted to the client.

In one embodiment, the physical interface of the first modem processor includes one of an I/O interface, a UART interface, a USB interface, and an I2C interface; and

the physical interface of the second modem processor includes one of an I/O interface, a UART interface, a USB interface, and an I2C interface.

In one embodiment, the second modem processor is further configured to perform network search and registration, authentication and other operations according to the received information of one or more of the first subscriber identity card and the second subscriber identity card.

Another aspect of the present disclosure includes a communication method applicable to a mobile terminal including a first subscriber identity card and a second subscriber identity card, comprising:

when a preset condition is satisfied, sending, by a second modem processor, a synchronization frame to a first modem processor;

after receiving the synchronization frame sent by the second modem processor, replying, by the first modem processor, an acknowledgement frame to establish a connection with the second modem processor;

registering, by the first modem processor, a preset service to obtain information of one or more of the first subscriber identity card and the second subscriber identity card; and

executing, by the second modem processor, service discovery and registering a client corresponding to the preset service to exchange the information of one or more of the first subscriber identity card and the second subscriber identity card with the first modem processor.

In one embodiment, a data packet format adopted for exchanging the information of one or more of the first subscriber identity card and the second subscriber identity card includes at least one of: a flag bit, a length, a control flag, a port number, a service ID, a customer ID, a data ID, a control bit, a message ID, a data length, and data.

In one embodiment, the method further includes:

configuring, for the first processor, a first logical port corresponding to the preset service and a second logical port corresponding to a physical interface of the first processor; and

transmitting the information of one or more of the first subscriber identity card and the second subscriber identity card to the second logical port through the first logical port, and to the second processor through the physical interface of the first processor.

In one embodiment, the method further includes:

configuring, for the second processor, a third logical port corresponding to a client and a fourth logical port corresponding to a physical interface of the second processor; and

transmitting the information of one or more of the first subscriber identity card and the second subscriber identity card received by the physical interface of the second processor to the third logical port through the fourth logical port, and to the client.

Another aspect of the present disclosure includes a mobile terminal, comprising:

a first subscriber identity card and a second subscriber identity card; and

a first modem processor and a second modem processor connected to the first modem processor, wherein:

the first modem processor is configured to obtain information of one or more of the first subscriber identity card and the second subscriber identity card; and

the first modem processor is further configured to transmit the obtained information of one or more of the first subscriber identity card and the second subscriber identity card to the second modem processor.

The dual-core communication method, device, mobile terminal, communication method, and storage medium in the disclosed embodiments of the present invention may have the following beneficial effects: a C/S communication architecture may be adopted between the first processor and the second processor to share information. Therefore, the first processor may share the obtained information with the second processor through a data interface, and, thus, the second processor may obtain the information instantly. Further, different ports may be registered for different services to perform corresponding transmission, which may support extending a plurality of transmission layer protocols and a plurality of physical layer protocols.

### BRIEF DESCRIPTION OF THE DRAWINGS

The present invention is further described below with reference to the accompanying drawings and embodiments. In the drawings:

FIG. 1 illustrates a schematic diagram of a hardware structure of a dual-core communication device consistent with an embodiment of the present invention;

FIG. 2 illustrates a schematic diagram of a software architecture of a dual-core communication device consistent with embodiments of the present invention;

FIG. 3 illustrates an interaction diagram of a first processor and a second processor of a dual-core communication device consistent with embodiments of the present invention;

FIG. 4 illustrates a format diagram of a data packet consistent with embodiments of the present invention;

FIG. 5 illustrates a schematic flowchart of a dual-core communication method consistent with embodiments of the present invention;

FIG. 6 illustrates a structural schematic diagram of a mobile terminal consistent with an embodiment of the present invention; and

FIG. 7 illustrates a schematic flowchart of a communication method consistent with an embodiment of the present invention.

### DETAILED DESCRIPTION

For clearer understanding of the technical characteristics, aims and effects of the present invention, specific embodiments of the present invention are now described in detail with reference to the accompanying drawings.

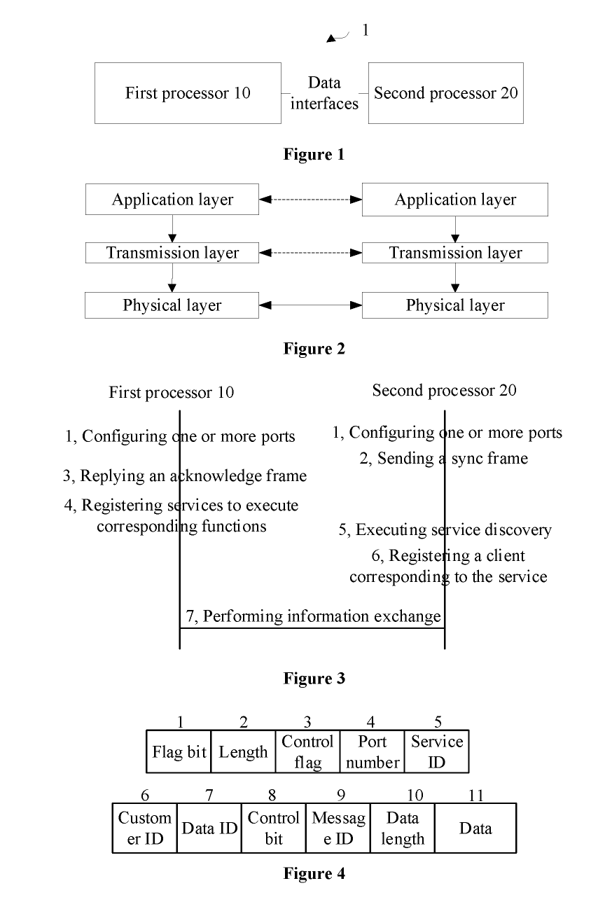

FIG. 1 illustrates a schematic diagram of a hardware structure of a dual-core communication device consistent with disclosed embodiments of the present invention. The dual-core communication device 1 may include a first processor 10 and a second processor 20 that are communicatively connected. In one embodiment, the first processor 10 and the second processor 20 may have one or more data interfaces. The first processor 10 and the second processor 20 may be connected through a data interface, e.g., a UART data interface, a USB data interface, etc.

Referring to FIG. 2, to implement information exchange between the first processor 10 and the second processor 20, a communication protocol between the first processor 10 and the second processor 20 may be divided into a physical layer, a transmission layer, and an application layer. Further, the physical layer may be used to send and receive data. The transmission layer may extend a plurality of interfaces, which may be used for corresponding different services enabled by the application layer, respectively. The application layer may be used to enable services to perform corresponding information acquisition functions.

Referring to FIG. 3, based on the foregoing hardware structure and the division of protocol layers, in disclosed embodiments of the present invention, the first processor 10 and the second processor 20 may be first configured with one or more ports, respectively. In the disclosed embodiments of the present invention, the port may be a virtual logical port, and configuring the port may include setting a port number for the port, etc. According to functions, the port may be divided into two types. The first type may be a port corresponding to a service registered by the application layer, and may transmit information obtained by the service of the application layer to the transmission layer. The second type may be a port corresponding to a physical interface of the physical layer, and may transmit information to the corresponding physical interface, thereby implementing the transmission (or reception) of information.

Specifically, the first processor 10 may register services to execute corresponding functions. In the disclosed embodiments of the present invention, the services may be preset services. For example, obtaining card information may be used as a preset service. When a preset condition is satisfied, after the second processor establishes a connection with the first processor by sending a synchronization frame, the first processor may register the preset service to perform the function of the preset service, e.g., obtaining the card information.

In the disclosed embodiments of the present invention, different services may have different functions. For example, a service for obtaining card information may be registered. Other types of services, e.g., services for obtaining status information, control information, etc., may also be registered in the disclosed embodiments of the present invention. Each one service may correspond to one port, that is, information obtained by the service may be transmitted through a port corresponding to the service. The port here may be referred to the first-type port described above.

Therefore, in the disclosed embodiments of the present invention, because a plurality of ports (the first-type ports described above) may be extended to correspond to different services, respectively, and different transmission layers may be invoked according to actual communication transmission demands to transmit information to interfaces (e.g., a USB interface, a shared memory interface, etc.) of the physical layer to support extending a plurality of transmission layer protocols. For example, for a first service, a transmission layer 1 may be invoked to transmit information, and for a second service, a transmission layer 2 may be invoked to transmit information. Different transmission layers may use different transmission layer protocols.

The second processor 20 may send a sync frame (synchronization frame) to the first processor 10. The first processor 10 may be further configured to reply an acknowledgement frame (ACK) after receiving the sync frame to establish a connection between the first processor 10 and the second processor 20. In the disclosed embodiments of the present invention, when a preset condition is satisfied, the second processor 20 may initiate the connection establishment process, that is, may send the sync frame. The preset condition may include boot, restart, and other performing initialization moments.

It should be understood that in the disclosed embodiments of the present invention, there is no sequential order in establishing the connection between the first processor 10 and the second processor 20 through sync and ACK and registering the service by the first processor 10. The first processor 10 may register the service either before or after establishing the connection.

The second processor 20 may execute service discovery and register a client corresponding to the service. In one embodiment, the client registered by the second processor 20 may correspond to the service registered by the first processor 10. Further, similar to the service registered by the first processor 10, the client registered by the second processor 20 may correspond to a corresponding port to transmit information to the transmission layer through the port, and to transmit the information to a corresponding physical interface through the port of the transmission layer.

After the second processor 20 registers the client, the first processor 10 and the second processor 20 may perform information exchange. Specifically, when performing the information exchange, a data packet format as shown in FIG. 4 may be used. The data packet format may include a flag bit (packet header part), a length (the length of the entire packet), a control flag (indicating a client or a server), a port number (local port), a service ID, a customer ID, a data ID, a control bit, a message ID, a data length, and data.

In one embodiment of the present invention, the port number may be a port number of the second-type port described above, which may be used to mark to which physical interface the data packet is transmitted. For example, when the physical interfaces include a USB interface and a shared memory interface, the data packet may be correctly transmitted to the corresponding physical interface through the port number to implement the exchange with the second processor 20. Therefore, after the data packet is transmitted to the physical layer, the field of port number may be deleted. That is, the data packet transmitted to the opposite end may not include the field of port number.

In one embodiment of the present invention, different physical interfaces (hardware interfaces) may have different port numbers. Therefore, by assigning a port number in the data packet, the data packet may be correctly forwarded, such that the information obtained by the service registered by the application layer may be transmitted through the exact physical interface. Therefore, the dual-core communication device in the disclosed embodiments of the present invention may support extending a plurality of physical interfaces (e.g., extending a plurality of physical layer protocols).

The service ID may be an ID number of the registered service. The client ID may be an ID number of the client corresponding to the service. The control bit may be used to identify whether the data packet is a request packet, a reply packet, etc. The data may use a ‘type-len-value’ format, where ‘type’ is used to represent a type of the entire data block, ‘len’ is used to represent a size of the ‘value’ field, and ‘value’ is the data field.

In the disclosed embodiments of the present invention, one service may have to transmit a plurality of data packets, and, thus, the message ID may represent a sequence number of the transmitted data packet. The data ID may be used to distinguish message type of the data packet. Each data packet may include a plurality of data with different types, thus, one message ID may correspond to a plurality of ‘type’. For example, a signal strength, a network format, and other information may be transmitted as one data packet, and types of different data blocks may be represented in the data field by ‘type’. Therefore, one data packet may transmit various information belonging to a same one message type.

It should be understood that the data packet format illustrated in FIG. 4 is merely exemplary, and other similar formats may be used.

In one embodiment of the present invention, specifically, the first processor 10 may be configured with a first logical port corresponding to a preset service, and configured with a second logical port corresponding to a physical interface of the first processor. Information obtained by the preset service may be transmitted to the second logical port through the first logical port, and then transmitted to the second processor through the physical interface of the first processor. The second processor 20 may be configured with a third logical port corresponding to a client, and configured with a fourth logical port corresponding to a physical interface of the second processor. Information received by the physical interface of the second processor may be transmitted to the third logical port through the fourth logical port, and then transmitted to the client.

In the disclosed embodiments of the present invention, when the second processor 20 shuts down or restarts abnormally, the second processor 20 may close the client and the ports. When the second processor 20 returns to normal, the connection with the first processor 10 may be re-established by sending a sync frame to re-execute the processes of registering the service, registering the client, etc., and to perform information exchange.

Similarly, if the first processor 10 shuts down or restarts abnormally, the first processor 10 may close the corresponding service and ports. When the first processor 10 returns to normal, the connection with the second processor 20 may be re-established by sending a sync frame to re-execute the processes of registering the service, registering the client, etc., and to perform information exchange.

In the dual-core communication device in the disclosed embodiments of the present invention, a C/S communication architecture may be adopted between the first processor and the second processor to share information. Therefore, the first processor 10 may share the obtained information with the second processor 20, and, thus, the second processor 20 may obtain the information instantly. Further, different ports may be registered for different services to perform corresponding transmission, which may support extending a plurality of transmission layer protocols and support extending a plurality of physical layer protocols.

Referring to FIG. 5, the disclosed embodiments of the present invention further provide a dual-core communication method, including the following:

S1: when the preset condition is satisfied, the second processor may send a synchronization frame to the first processor;

S2: after receiving the synchronization frame sent by the second processor, the first processor may reply an acknowledgement frame to establish a connection with the second processor;

S3: the first processor may register a preset service; and

S4: the second processor may execute service discovery and register a client corresponding to the preset service to perform information exchange with the first processor.

The above steps S1, S2, and S3 may have no order restrictions.

The data packet format adopted for information exchange may include at least one of the following fields: the flag bit, the length, the control flag, the port number, the service ID, the customer ID, the data ID, the control bit, the message ID, the data length, and the data. The data may include a field indicating the type of the entire data block, a field indicating the size of the data field, and the data field.

The dual-core communication method in the disclosed embodiments of the present invention may further include configuring a first logical port corresponding to a preset service, and a second logical port corresponding to a physical interface of the first processor for the first processor.

Information obtained by the preset service may be transmitted to the second logical port through the first logical port, and then transmitted to the second processor through the physical interface of the first processor.

The dual-core communication method in the disclosed embodiments of the present invention may further include configuring a third logical port corresponding to a client, and a fourth logical port corresponding to a physical interface of the second processor for the second processor.

Information received by the physical interface of the second processor may be transmitted to the third logical port through the fourth logical port, and then transmitted to the client.

The physical interface of the first processor may include an I/O interface, a UART interface, a USB interface, or an I2C interface. The physical interface of the second processor may include an I/O interface, a UART interface, a USB interface, or an I2C interface.

In the dual-core communication method in the disclosed embodiments of the present invention, a C/S communication architecture may be adopted between the first processor and the second processor to share information. Different ports may be registered for different services to perform corresponding transmission, which may support extending a plurality of transmission layer protocols and a plurality of physical layer protocols.

It should be understood that implementation details and principles of the dual-core communication device described above are also applicable to the dual-core communication method, which are not repeated herein.

The disclosed embodiments of the present invention further provide a first computer storage medium. Computer programs may be stored in the first computer storage medium, and the computer programs may be used to execute the dual-core communication method shown in FIG. 5 in the disclosed embodiments of the present invention.

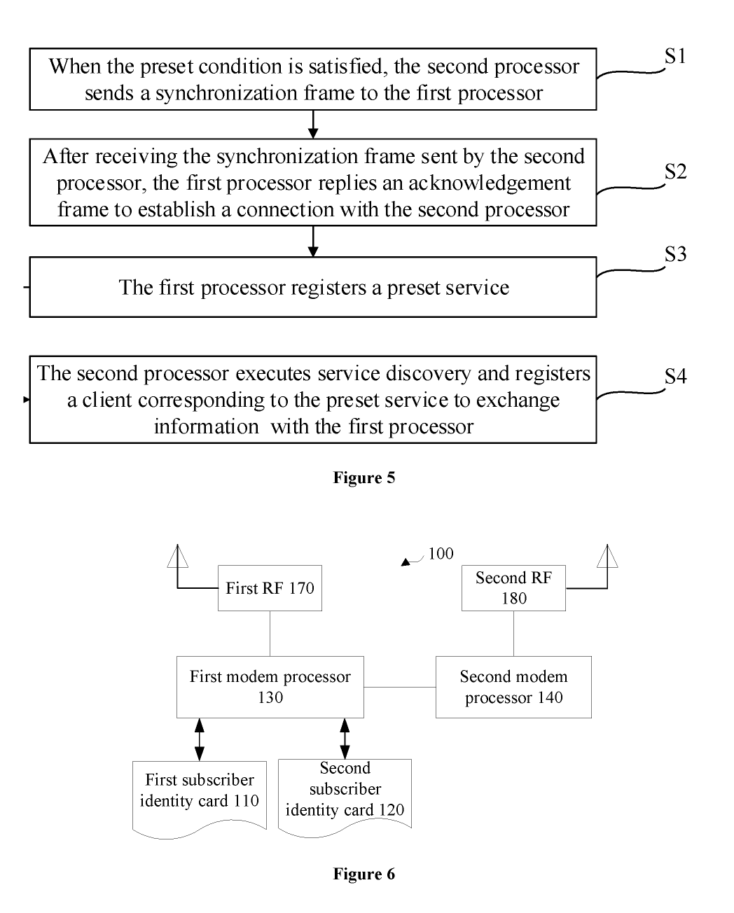

FIG. 6 illustrates a structural schematic diagram of a mobile terminal consistent with disclosed embodiments of the present invention. In one embodiment, the mobile terminal may employ the dual-core communication method described above to perform subscriber identity card information exchange.

In one embodiment, the terminal 100 may include a first modem processor 130, a second modem processor 140, a first radio frequency 170, a second radio frequency 180, a first subscriber identity card 110, and a second subscriber identity card 120.

The first subscriber identity card 110 may be placed in a first card slot (not shown in FIG. 1). The second subscriber identity card 120 may be placed in a second card slot (not shown in FIG. 1). In one embodiment, the first card slot and the second card slot may adopt an ‘independent-card-slot’ manner, that is, may include two independent card trays to carry the first subscriber identity card and the second subscriber identity card, respectively. In another embodiment, the first card slot and the second card slot may adopt a ‘one-carry-two’ manner, that is, may merely include one card tray including two card slots.

The subscriber identity card in the disclosed embodiments of the present invention may be used to identify and authenticate users for the network. For example, the subscriber identity card may include a universal subscriber identity module (USIM), a subscriber identity module (SIM), etc. In certain embodiments, the subscriber identity card may store one or more of the following information: a unique serial number (ICCID), an international mobile subscriber identity (IMSI), security authentication and encryption information, temporary information related to a local network, a user access list of services, a personal identification number (PIN), and a personal unlocking key (PUK) for PIN unlocking.

The terminal 100 may include any mobile, portable computing or communication device, e.g., a cellular device, capable of connecting with a network. For example, the terminal 100 may be a cellular phone (mobile phone), a navigation system, a computing device, a camera, a PDA, a music device, a game device, or a handheld device with wireless connection capabilities.

In the disclosed embodiments of the present invention, the terminal 100 may be a device that accesses a network based on subscription information in a subscriber identity card. The first subscriber identity card 110 may be associated with a first subscription, and the second subscriber identity card 120 may be associated with a second subscription. The first subscription and the second subscription may be voice and/or data subscriptions. The first subscription and the second subscription may be associated with a same technology type, a same network operator, different technology types and/or different network operators. The technology type and/or network may include 4G technologies, e.g., but not limited to, long-term evolution (LTE), time division long-term evolution (TD-LTE), EUTRAN (4G LTE), or any other fourth generation mobile communication technology.

When performing network search and network registration, a type of a subscriber identity card may be identified according to the information stored in the subscriber identity card. Therefore, according to the type of the subscriber identity card, corresponding network parameters may be loaded to perform network search and network registration. Thus, the terminal 100 may use the first subscription associated with the first subscriber identity card 110 to communicate with the network, and may use the second subscription associated with the second subscriber identity card 120 to communicate with the network. It should be understood that the network parameters may include frequency bands, channel numbers, and other parameters required for network search and network registration. Different subscriber identity cards may correspond to different operators, and may correspond to different network parameters. For example, when it is determined that the subscriber identity card is China Mobile based on the IMSI, the corresponding network parameters of China Mobile may be loaded to complete the network registration.

The network parameters may be stored in a memory (not illustrated in FIG. 1). In the disclosed embodiments of the present invention, the number of the network parameter files may be associated with the operators supported by the terminal. For example, when the terminal supports three major operators, the number of the network parameter files may be three. When the terminal supports global communication, the number of network parameter files may reach 217 (the number of operators worldwide is 217).

The memory may be any available storage medium that can be accessed by a general or special purpose application, for example, may include RAM, ROM, EEPROM, disk storage, or other magnetic storage devices.

The first modem processor 130 may be configured to complete protocol processing and configured to perform modulation and demodulation on the transmitted and received communication data to achieve communication with an external communication device, etc. Further, the protocol processing may include a protocol that executes a network standard for processing various network interactions, e.g., protocol codes defined in LTE/WCDMA/GSM/TDSCDMA/1×/CDMA/EVDO and other communication standards. These standard protocols may be mandatory for a user device to interact with operator's network (e.g., surfing the Internet via data, calling via VOLTE, or calling via CS circuit domain, etc.).

The second modem processor 140 may be configured to complete protocol processing and configured to perform modulation and demodulation on the transmitted and received communication data to achieve communication with an external communication device, etc. Further, the protocol processing may include a protocol that executes a network standard for processing various network interactions, e.g., protocol codes defined in LTE/WCDMA/GSM/TDSCDMA/1×/CDMA/EVDO and other communication standards. These standard protocols may be mandatory for a user device to interact with operator's network.

The first radio frequency 170 and the second radio frequency 180 may be configured to perform up-conversion, down-conversion, filtering, amplifying, transmitting, and receiving, etc., of the signal. Wireless access technologies involved with the first radio frequency 170 and the second radio frequency 180 may include LTE, GSM, and GPRS, etc.

In the disclosed embodiments of the present invention, the terminal 100 may simultaneously use data networks of the two subscriber identity cards and download data jobs at the same time to achieve the purpose of dual-concurrent data download acceleration. Therefore, a same one subscriber identity card may be capable of being accessed by the first modem processor 130 and the second modem processor 140. The access referred to here may be reading and writing information of the subscriber identity card to implement network communication through the first subscription associated with the first subscriber identity card 110 and network communication through the second subscription associated with the second subscriber identity card 120.

Referring to FIG. 6, in the disclosed embodiments of the present invention, both of the two subscriber identity cards may be connected to the first modem processor 130 in a hardware structure. In one embodiment, the first modem processor 130 may be connected to the first subscriber identity card 110 and the second subscriber identity card 120 through a UART data interface, respectively, to perform read and write operations on the first subscriber identity card 110 and the second subscriber identity card 120.

The second modem processor 140 may obtain the information of the subscriber identity card through exchange with the first modem processor 130. Specifically, in one embodiment of the present invention, the first modem processor 130 may be connected to the second modem processor 140 through a data interface (e.g., a UART data interface) to transfer information of the subscriber identity card to the second modem processor 140.

To implement the card information exchange between the first modem processor 130 and the second modem processor 140, a communication protocol between the first modem processor 130 and the second modem processor 140 may be divided into a physical layer, a transmission layer, and an application layer. Further, the physical layer may be used to send and receive data. The transmission layer may extend a plurality of interfaces, which may be used for corresponding different services enabled by the application layer, respectively. The application layer may be used to enable services to perform corresponding information acquisition functions.

Specifically, when the preset condition is satisfied, the second modem processor 140 may be configured to send a synchronization frame to the first modem processor 130.

The first modem processor 130 may be configured to reply an acknowledge frame to establish a connection with the second modem processor 140 after receiving the synchronization frame sent by the second modem processor.

The first modem processor 130 may be further configured to register a preset service to obtain information of the first subscriber identity card 110 and/or the second subscriber identity card 120.

The second modem processor 140 may be further configured to execute service discovery and register a client corresponding to the preset service to exchange the information of the first subscriber identity card 110 and/or the second subscriber identity card 120 with the first modem processor 130.

The data packet format adopted for subscriber identity card information exchange may include at least one of the following fields: the flag bit, the length, the control flag, the port number, the service ID, the customer ID, the data ID, the control bit, the message ID, the data length, and the data. The data may include a field indicating the type of the entire data block, a field indicating the size of the data field, and the data field.

The first modem processor 130 may be configured with a first logical port corresponding to a preset service, and configured with a second logical port corresponding to a physical interface of the first modem processor 130. The information of the first subscriber identity card 110 and/or the second subscriber identity card 120 may be transmitted to the second logical port through the first logical port, and then transmitted to the second modem processor 140 through the physical interface of the first modem processor 130.

The second modem processor 140 may be configured with a third logical port corresponding to a client, and configured with a fourth logical port corresponding to a physical interface of the second modem processor 140. The information of the first subscriber identity card 110 and/or the second subscriber identity card 120 received by the physical interface of the second modem processor 140 may be transmitted to the third logical port through the fourth logical port, and then transmitted to the client.

The physical interface of the first modem processor 130 may include an I/O interface, a UART interface, a USB interface, or an I2C interface. The physical interface of the second modem processor 140 may include an I/O interface, a UART interface, a USB interface, or an I2C interface.

It should be understood that the implementation details and principles of the dual-core communication device described above are also applicable to the mobile terminal in the disclosed embodiments, which are not repeated herein.

After the second modem processor obtains the information of the subscriber identity card by using the subscriber identity card information sharing scheme described above, a network search and registration process may include:

In one embodiment of the present invention, the first subscriber identity card may be used as a primary card, and the second subscriber identity card may be used as a secondary card. Then, when searching and registering the network, the first modem processor may obtain the information of the first subscriber identity card, and load network parameters corresponding to the first subscriber identity card according to the obtained information, to register CS voice service and PS data service of the first subscriber identity card in a first network. The first modem processor may further obtain information of the second subscriber identity card, and load network parameters corresponding to the second subscriber identity card according to the obtained information, to register CS voice service of the second subscriber identity card in the first network.

The first modem processor may further send the obtained information of the second subscriber identity card to the second modem processor. The second modem processor may register PS data service of the second subscriber identity card in a second network according to the received information of the second subscriber identity card.

In another embodiment of the present invention, the primary card and the secondary card may not be distinguished. When searching and registering the network, the first modem processor may obtain the information of the first subscriber identity card, and load network parameters corresponding to the first subscriber identity card according to the obtained information, to register CS voice service and PS data service of the first subscriber identity card in the first network. The first modem processor may further obtain information of the second subscriber identity card, and send the obtained information of the second subscriber identity card to the second modem processor. The second modem processor may register CS voice service and PS data service of the second subscriber identity card in the second network according to the received information of the second subscriber identity card.

In the disclosed embodiments of the present invention, the first network and the second network may be different networks of different operators, or may be same or different networks of a same operator. In one embodiment, both the first network and the second network may be 4G networks.

In the mobile terminal in the disclosed embodiments of the present invention, a C/S communication architecture may be adopted between the first modem processor and the second modem processor to share information. Therefore, the first modem processor may share the obtained information with the second modem processor through a data interface, and, thus, the second modem processor may obtain the information instantly, which may save costs. Further, different ports may be registered for different services to perform corresponding transmission, which may support extending a plurality of transmission layer protocols and a plurality of physical layer protocols.

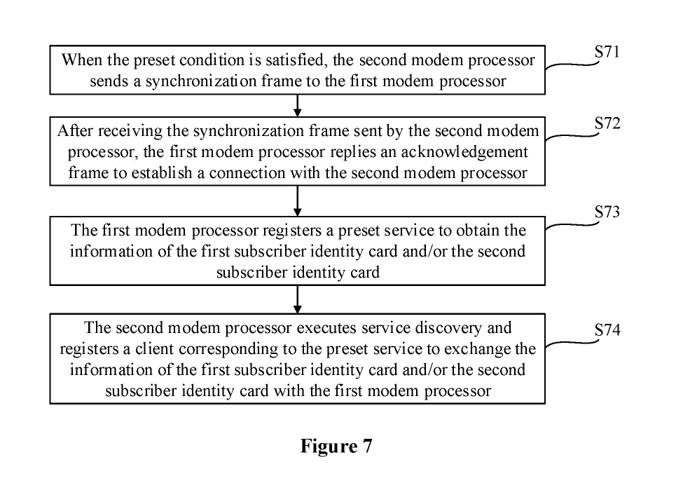

FIG. 7 illustrates a schematic flowchart of a communication method in one embodiment of the present invention. Referring to FIG. 7, in the disclosed embodiments, the communication method may include the following:

S71: when the preset condition is satisfied, the second modem processor may send a synchronization frame to the first modem processor;

S72: after receiving the synchronization frame sent by the second modem processor, the first modem processor may reply an acknowledgement frame to establish a connection with the second modem processor;

S73: the first modem processor may register a preset service to obtain information of the first subscriber identity card and/or the second subscriber identity card; and

S74: the second modem processor may execute service discovery and register a client corresponding to the preset service to exchange the information of the first subscriber identity card and/or the second subscriber identity card with the first modem processor.

The above steps S71, S72, and S73 may have no order restrictions.

The data packet format adopted for subscriber identity card information exchange may include at least one of the following fields: the flag bit, the length, the control flag, the port number, the service ID, the customer ID, the data ID, the control bit, the message ID, the data length, and the data.

The communication method in the disclosed embodiments of the present invention may further include configuring a first logical port corresponding to the preset service, and a second logical port corresponding to a physical interface of the first modem processor for the first modem processor. The information of the first subscriber identity card and/or the second subscriber identity card may be transmitted to the second logical port through the first logical port, and then transmitted to the second modem processor through the physical interface of the first modem processor.

The communication method in the disclosed embodiments of the present invention may further include configuring a third logical port corresponding to a client, and a fourth logical port corresponding to a physical interface of the second modem processor for the second modem processor. The information of the first subscriber identity card and/or the second subscriber identity card received by the physical interface of the second modem processor may be transmitted to the third logical port through the fourth logical port, and then transmitted to the client.

The disclosed embodiments of the present invention further provide a second computer storage medium. Computer programs may be stored in the second computer storage medium, and the computer programs may be used to execute the communication method shown in FIG. 7 in the disclosed embodiments of the present invention.

It should be understood that the implementation details and principles of the dual-core communication device described above are also applicable to the mobile terminal in the disclosed embodiments, which are not repeated herein.

In the disclosed embodiments of the present invention, the first modem processor may obtain the information of the subscriber identify card and transmit the obtained information of the subscriber identify card to the second modem processor. The second modem processor may perform network registration, authentication and other operations according to the received card information.

In addition, according to the method for obtaining subscriber identity card information in the disclosed embodiments of the present invention, the second modem processor may further perform read and write operations on the first subscriber identity card and/or the second subscriber identity card.

In the dual-core communication method, device, mobile terminal, communication method, and storage medium in the disclosed embodiments of the present invention, a C/S communication architecture may be adopted between the first processor and the second processor to share information. Therefore, the first processor may share the obtained information with the second processor through a data interface, and, thus, the second processor may obtain the information instantly. Further, different ports may be registered for different services to perform corresponding transmission, which may support extending a plurality of transmission layer protocols and a plurality of physical layer protocols.

In the disclosed embodiments of the present invention, ‘plurality’ refers to two or more unless otherwise specified. In the description of the present invention, it should be understood that terms ‘first’, ‘second’, etc. are merely used for descriptive purposes and are not to be construed as indicating or implying relative importance.

Any process or method description described in the flowcharts or described in other manners in the disclosed embodiments of the present invention may be understood as a unit, a segment, or a section of codes that includes one or more executable instructions for implementing steps of a specific logical function or process. The scope of the disclosed embodiments of the present invention may include additional implementations in which functions may be performed not in the order shown or discussed, and may be performed in a substantially simultaneous manner or in reverse order, depending on the functionality involved. This should be understood by those skilled in the art described in the disclosed embodiments of the present invention.

For purposes of explanation, the foregoing description uses specific terms to provide a thorough understanding of the present invention. However, it will be apparent to those skilled in the art that specific details are not required to practice the invention. The foregoing description of specific embodiments of the invention has been presented for the purposes of illustration and description. They are not intended to be exhaustive or to limit the invention to the precise forms disclosed. In view of the above teachings, many modifications and variations are possible. These embodiments are shown and described to best explain the principles of the invention and its practical applications, thereby enabling others skilled in the art to best utilize the invention and various embodiments with various modifications suited to the particular applications. It is intended that the scope of the invention is defined by the following claims and their equivalents.

### INDUSTRIAL APPLICABILITY

In the disclosed embodiments of the present invention, a C/S communication architecture may be adopted between the first processor and the second processor to share information. Therefore, the first processor may share the obtained information with the second processor through a data interface and, thus, the second processor may obtain the information instantly. Further, different ports may be registered for different services to perform corresponding transmission, which may support extending a plurality of transmission layer protocols and a plurality of physical layer protocols.

1. A dual-core communication method, comprising:
when a preset condition is satisfied, sending, by a second processor, a synchronization frame to a first processor;
after receiving the synchronization frame sent by the second processor, replying, by the first processor, an acknowledgement frame to establish a connection with the second processor;
registering, by the first processor, a preset service; and
executing, by the second processor, service discovery and registering a client corresponding to the preset service to exchange information with the first processor.

2. The method according to claim 1, wherein:
the preset service includes a service for obtaining information of a subscriber identity card; and
exchanging information includes exchanging the information of the subscriber identity card obtained by the first processor.

3. The method according to claim 1, wherein:
a data packet format adopted for exchanging information includes at least one of: a flag bit, a length, a control flag, a port number, a service ID, a customer ID, a data ID, a control bit, a message ID, a data length, and data.

4. The method according to claim 3, wherein:
the data includes a field indicating a type of an entire data block, a field indicating a size of a data field, and the data field.

5. The method according to claim 1, further including:
configuring, for the first processor, a first logical port corresponding to the preset service and a second logical port corresponding to a physical interface of the first processor; and
transmitting information obtained by the preset service to the second logical port through the first logical port, and to the second processor through the physical interface of the first processor.

6. The method according to claim 5, further including:
configuring, for the second processor, a third logical port corresponding to a client and a fourth logical port corresponding to a physical interface of the second processor; and
transmitting information received by the physical interface of the second processor to the third logical port through the fourth logical port, and to the client.

7. The method according to claim 6, wherein:
the physical interface of the first processor includes one of an I/O interface, a UART interface, a USB interface, and an I2C interface; and
the physical interface of the second processor includes one of an I/O interface, a UART interface, a USB interface, and an I2C interface.

8. (canceled)

9. (canceled)

10. (canceled)

11. A mobile terminal, comprising:
a first subscriber identity card and a second subscriber identity card; and
a first modem processor and a second modem processor connected to the first modem processor, wherein:
when a preset condition is satisfied, the second modem processor is configured to send a synchronization frame to the first modem processor;
after receiving the synchronization frame sent by the second modem processor, the first modem processor is configured to reply an acknowledgement frame to establish a connection with the second modem processor;
the first modem processor is configured to register a preset service to obtain information of one or more of the first subscriber identity card and the second subscriber identity card; and
the second modem processor is configured to execute service discovery and register a client corresponding to the preset service to exchange the information of one or more of the first subscriber identity card and the second subscriber identity card with the first modem processor.

12. The mobile terminal according to claim 11, wherein:
a data packet format adopted for exchanging the information of one or more of the first subscriber identity card and the second subscriber identity card includes at least one of: a flag bit, a length, a control flag, a port number, a service ID, a customer ID, a data ID, a control bit, a message ID, a data length, and data.

13. The mobile terminal according to claim 12, wherein:
the data includes a field indicating a type of an entire data block, a field indicating a size of a data field, and the data field.

14. The mobile terminal according to claim 11, wherein:
the first modem processor is further configured with a first logical port corresponding to the preset service and a second logical port corresponding to a physical interface of the first modem processor; and
information of one or more of the first subscriber identity card and the second subscriber identity card is transmitted to the second logical port through the first logical port, and transmitted to the second modem processor through the physical interface of the first modem processor.

15. The mobile terminal according to claim 14, wherein:
the second modem processor is further configured with a third logical port corresponding to a client and a fourth logical port corresponding to a physical interface of the second modem processor; and
the information of one or more of the first subscriber identity card and the second subscriber identity card received by the physical interface of the second modem processor is transmitted to the third logical port through the fourth logical port, and transmitted to the client.

16. The mobile terminal according to claim 15, wherein:
the physical interface of the first modem processor includes one of an I/O interface, a UART interface, a USB interface, and an I2C interface; and
the physical interface of the second modem processor includes one of an I/O interface, a UART interface, a USB interface, and an I2C interface.

17. The mobile terminal according to claim 11, wherein:
the second modem processor is further configured to perform network search and registration, authentication and other operations according to the received information of one or more of the first subscriber identity card and the second subscriber identity card.

18. The method according to claim 1, further comprising:
when the method is applicable to a mobile terminal including a first subscriber identity card and a second subscriber identity card,
when a preset condition is satisfied, sending, by a second modem processor, a synchronization frame to a first modem processor;
after receiving the synchronization frame sent by the second modem processor, replying, by the first modem processor, an acknowledgement frame to establish a connection with the second modem processor;
registering, by the first modem processor, a preset service to obtain information of one or more of the first subscriber identity card and the second subscriber identity card; and
executing, by the second modem processor, service discovery and registering a client corresponding to the preset service to exchange the information of one or more of the first subscriber identity card and the second subscriber identity card with the first modem processor.

19. A non-transitory computer-readable storage medium, having computer-executable instructions programs thereon, wherein, when being executed, the computer-executable instructions cause a processor to perform a dual-core communication method, the method comprising:
when a preset condition is satisfied, sending, by a second processor, a synchronization frame to a first processor;
after receiving the synchronization frame sent by the second processor, replying, by the first processor, an acknowledgement frame to establish a connection with the second processor;
registering, by the first processor, a preset service; and
executing, by the second processor, service discovery and registering a client corresponding to the preset service to exchange information with the first processor.

20. (canceled)

21. The medium according to claim 19, wherein:
the preset service includes a service for obtaining information of a subscriber identity card; and
exchanging information includes exchanging the information of the subscriber identity card obtained by the first processor.

22. The medium according to claim 19, wherein the method further includes:
configuring, for the first processor, a first logical port corresponding to the preset service and a second logical port corresponding to a physical interface of the first processor; and
transmitting information obtained by the preset service to the second logical port through the first logical port, and to the second processor through the physical interface of the first processor.

23. The medium according to claim 19, wherein the method further includes:
configuring, for the second processor, a third logical port corresponding to a client and a fourth logical port corresponding to a physical interface of the second processor; and
transmitting information received by the physical interface of the second processor to the third logical port through the fourth logical port, and to the client.

24. The medium according to claim 19, wherein the method further includes:
when the method is applicable to a mobile terminal including a first subscriber identity card and a second subscriber identity card,
when a preset condition is satisfied, sending, by a second modem processor, a synchronization frame to a first modem processor;
after receiving the synchronization frame sent by the second modem processor, replying, by the first modem processor, an acknowledgement frame to establish a connection with the second modem processor;
registering, by the first modem processor, a preset service to obtain information of one or more of the first subscriber identity card and the second subscriber identity card; and
executing, by the second modem processor, service discovery and registering a client corresponding to the preset service to exchange the information of one or more of the first subscriber identity card and the second subscriber identity card with the first modem processor.
